(19) United States
(12) Patent Application Publication
(10) Pub. No.: US 2017/0108147 A1
(43) Pub. Date: Apr. 20, 2017

(54) Means and Methods of Cable Organization

(71) Applicant: Daniel L. Cindrich, Fairfax, CA (US)

(72) Inventor: Daniel L. Cindrich, Fairfax, CA (US)

(21) Appl. No.: 15/294,419

(22) Filed: Oct. 14, 2016

Related U.S. Application Data
(60) Provisional application No. 62/241,597, filed on Oct. 14, 2015.

(51) Int. Cl. F16L 3/22; F16L 3/10

(52) U.S. Cl. CPC F16L 3/22; F16L 3/10

(57) ABSTRACT

A cable organizer or comb 100 may comprise a plurality of free floating row members or fingers 320 such that the free floating members may be inserted into a tangled web of cables without the need to unplug the cables or find the ends of the cables. A plurality of free floating members may be combined to define a plurality of cable voids 330 and the plurality of free floating members may be retained by a collar system 200.

### CROSS-REFERENCE TO RELATED APPLICATIONS

This utility patent application claims the benefit and priority of provisional patent application 62,241,597 filed on Oct. 14, 2015, the contents of which are incorporated herein by reference.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

(1) Field of the Invention

The invention generally relates to cable organization retention systems. More particularly, the invention relates to means and methods of straining or combing cables.

(2) Description of the Related Art

The known related art fails to anticipate or disclose the principles of the present invention.

In the related art other means of cable organization are known, but fail to provide efficient means of organizing cable wherein the cable ends are not accessible. For example, U.S. Pat. No. 4,715,571 by Soltow et al issued on Dec. 29, 1987 discloses a star shaped system with a solid center section. The solid center section of Stoltow, shown as reference number 26 in FIG. 4, requires the entire Stoltow system to be placed in the center of a wire bundle. Such center placement is not possible or practical in applications where the wires are already secured at one end. The tubing organizer by Schattner et al suffers the same shortfall. The tubing organizer by Schattner may be found in U.S. Pat. No. 6,375,017 granted on Apr. 23, 2017.

U.S. Pat. No. 6,710,249 by Denton issued on Mar. 23, 2004 discloses a monolithic wire separator that fails to allow insertion within an existing bundle of wires. The cable/wire dressing tool by Pappas found in U.S. Pat. No. 7,073,541 suffers the same shortfall. The network cable bundling tool by Vermeer et al as found in U.S. Pat. No. 7,959,113 issued on Jun. 14, 2011 does provide curves to accommodate cables held in series of rows, but Vermeer contains a center component, preventing the use of the Vermeer system in pre-bundled wire applications.

The known prior art fails to provides means or methods of organizing cables or wires midstream wherein unplugging or accessing the ends of the cables or wires is not possible.

Thus, there is a long felt need in the art for the present invention.

### BRIEF SUMMARY OF THE INVENTION

The present invention overcomes shortfalls in the related art by presenting an unobvious and unique combination and configuration of methods and components to organize assemble and catalog groups of wires midstream, wherein wire end insertion is not practical.

The invention overcomes shortfalls in the related art by using a plurality of free floating row members or fingers that may be easily inserted into a tightly grouped collection of cables. The insertion of each free floating row member does not require access or movement of any wire end.

Disclosed embodiments overcome shortfalls in the art by providing peripheral configurations that comport with a collar system that secures the free floating members. Thus, after the insertion of one or more free floating members, a collar system may secure or retain the free floating members. Free floating members or fingers may be retained by use of magnets or other means.

The invention overcomes shortfalls in the related art by providing technicians an ability to organize cables without unplugging cable ends. Often, a technician is faced with pre-existing “spaghetti wire” nests of tangled cable, with the cable ends terminating in different rooms, or cable lengths sequestered under a subfloor or other inaccessible area.

After a cluster of wires has been contained by a disclosed embodiment, the wires or cables may be combed or strained. Disclosed embodiments may also be used in new construction wherein boxes or spools of wires, cables, hoses, ropes and similar objects are organized and/or cataloged prior to being pulled through walls, floors, ceilings or conduits.

Disclosed embodiments overcome shortfalls in the art by the construction of well-organized bundles of cable, with such organization conducive to pinpoint replacement of individual cables.

These and other objects and advantages will be made apparent when considering the following detailed specification when taken in conjunction with the drawings.

### BRIEF DESCRIPTION OF THE DRAWINGS

FIG. 1 depicts a perspective view and an exploded view of a disclosed embodiment

FIG. 2 depicts a plan of a dissembled embodiment

FIG. 3 depicts a perspective view of a dissembled group of free floating members or fingers

FIG. 4 depicts a perspective view of a disclosed embodiment

FIG. 5 depicts a perspective view of a disclosed embodiment

FIG. 6 depicts a perspective view of a disclosed embodiment

FIG. 7 depicts a perspective view of a disclosed embodiment

FIG. 8 depicts a perspective view of a disclosed embodiment

FIG. 9 depicts a perspective view of a disclosed embodiment in use

FIG. 10 depicts a plan view of a disclosed embodiment

FIG. 11 depicts a perspective view of a disclosed embodiment in an unassembled configuration

FIG. 12 depicts a perspective view of a free floating end cap

FIG. 13 depicts a perspective view of a free floating end cap

FIG. 14 depicts a perspective view of a free floating member

FIG. 15 depicts a perspective view of a free floating member

### REFERENCE NUMERALS IN THE DRAWINGS

100 a disclosed embodiment in general

200 a collar system

212 inner arch of collar system

300 free floating member assembly or system

310 free floating end cap or termination divider component

312 outer arch of free floating end cap 310

320 free floating member or finger or inner divider component

322 inner arch component

324 wall components

326 side block area, used to attach to the collar system 200

330 cable voids defined within a free floating member

335 configuration of staggered cable voids to maximize the number of retained cables

337 centerline of voids 330, showing voids to be staggered

340 outer voids to accept a collar system 200

350 outer extended lips to further secure a collar system 200

370 connection pin attached to a free floating member 320 or free floating end cap 310

373 connection void, configured to accept a connection pin 370, the connection void defined within a free floating member or free floating end cap 400 wire

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

### Further Advantages and Features of the Disclosed Embodiments

Disclosed embodiments may be made of any material, such as plastic, aluminum or carbon fiber. Disclosed components may be derived from 3D printing, CNC fabrication, injection molding and other methods. The free floating fingers or free floating components may be attached to one another by use of pin and hole systems, magnets and/or collar systems. Magnets have been found to be useful in temporarily securing free floating fingers in preparation for collar attachment.

Disclosed embodiments may be made to different scales or sizes to accommodate various applications such as data center network wiring, small business or home network wiring, and audio, video, lighting, shading and other applications. Disclosed embodiments comprise a plurality of wire voids, with the number of such wire voids configured to comport with any application.

The use of disclosed embodiments results in aesthetically pleasing and professional looking bundles of well-organized wires or cables. Voids and or cable contained within voids may be numbered or otherwise cataloged to facilitate cable identification and cable “peel off.”

The use of disclosed embodiments helps to reduce cable burn and eases cable installation and cable stretching in rounding corners or in other directional changes. In one disclosed method, wires may be individually pulled and then organized. Such a method allows for wires of different finished lengths to be pulled without cable burn and to be well organized.

Disclosed embodiments may be integrated with software, computer systems and other systems such as D-Tools such that wire bundles may be automatically configured via software based upon schematic drawings.

Disclosed embodiments may include or include the use of various adaptors or clamshell handles to facilitate various job requirements or applications such as: regular pull, rack pull, conduit pull, fixed to wall for pulling premise wire through walls, and weighted base.

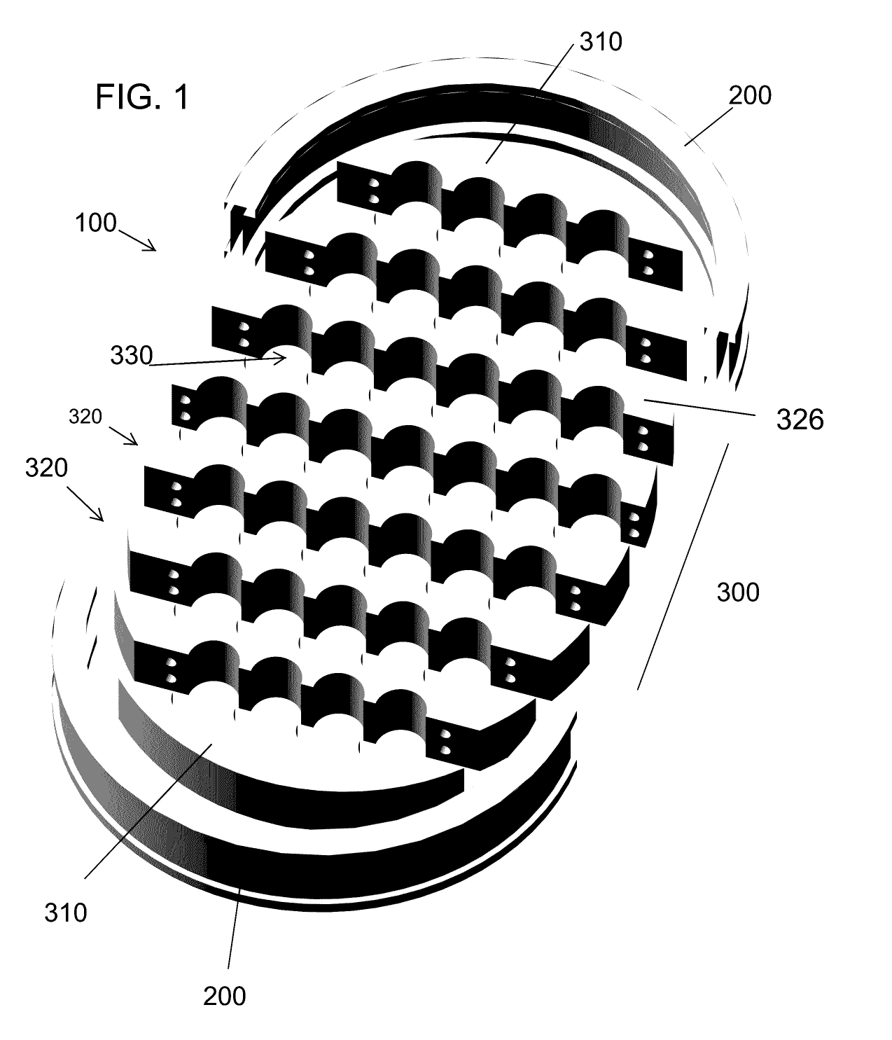

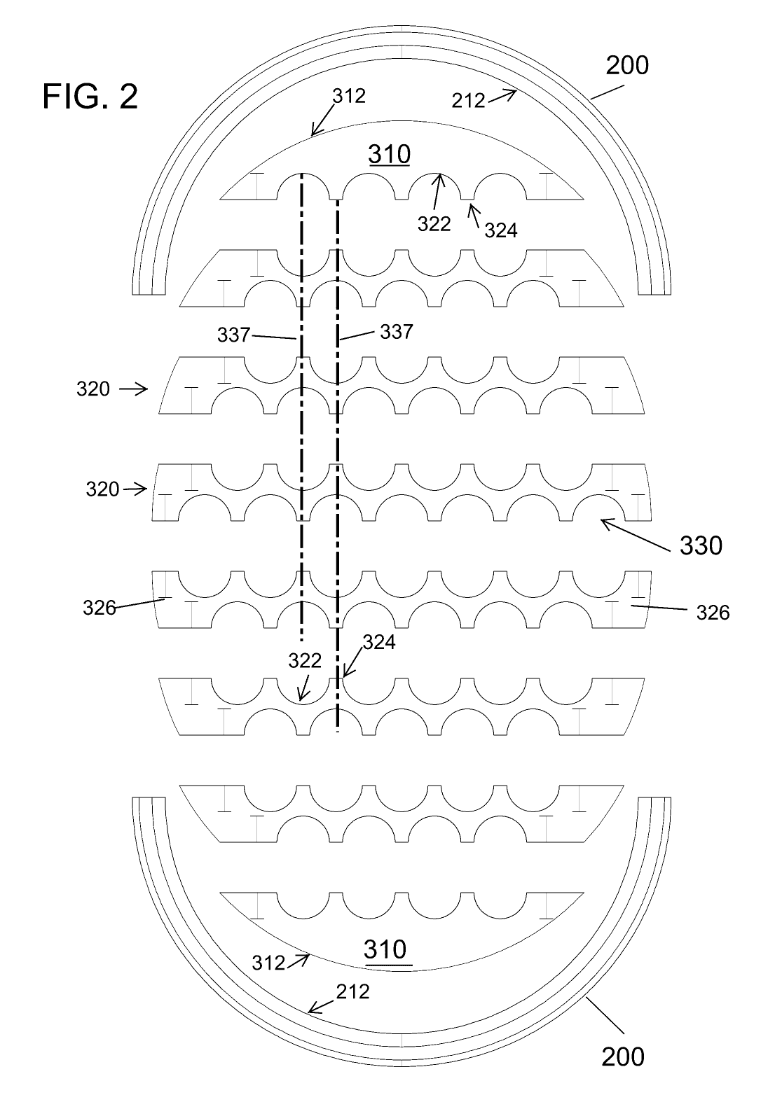

FIG. 1 and FIG. 2 depict a disclosed embodiment 100 which may comprise a free floating member assembly 300 with the free floating member assembly comprising a plurality of free floating members 320. Each free floating member may comprise a plurality of inner arch components 322 and wall components 324 such that when free floating members are attached to one another, cable voids 330 are defined. The inner arch components 332 and wall components 324 overcome shortfalls in the art by allowing the free floating members to be detached and thus be inserted into a tangled web of cables. If the free floating members did not define cable voids, the ends of cable voids would need to be accessible such that the cable void ends could be inserted through the voids.

Each free floating finger may have a first side and a second side, with the first side and second side comprising a side block area 326, each side block area overcomes shortfalls in the art by providing a point of attachment for each free floating finger 320, without a point of attachments, the free floating fingers could not be independently inserted into a tangled ball of cable. The side block areas 326 comport with the inner sections of the collar system, allowing the collar system to retain the plurality of free floating fingers.

A plurality of free floating fingers 320 compressed together will leave a top side and a bottom side with uncompleted cable voids and without means of efficient retention. To solve this problem, the disclosed embodiments may include a top and bottom free floating end cap 310 or termination divider component. Each free floating end cap 310 may comprise an inner side, with the inner side comprising one or more inner arch components 322 and one or more wall components 324. A free floating end cap 310 may also comprise an outer arch 312 that may comport with an inner arch 212 of a collar system 200. The curved surface of the inner arch 212 is useful to comport with the outer arch 312. The matting of the collar system 200 with the floating end caps 310 and free floating fingers 320, allows for cable combing and cable organization with existing cables with cable ends not readily accessible.

Disclosed embodiments also overcome shortfalls in the art by the use of staggered cable voids, as staggered cable voids maximize the number of voids defined within a cable organization system. A center line 337 is drawn over alternating inner arch components 322 and wall components 324 to demonstrate a disclosed alternating cable void configuration.

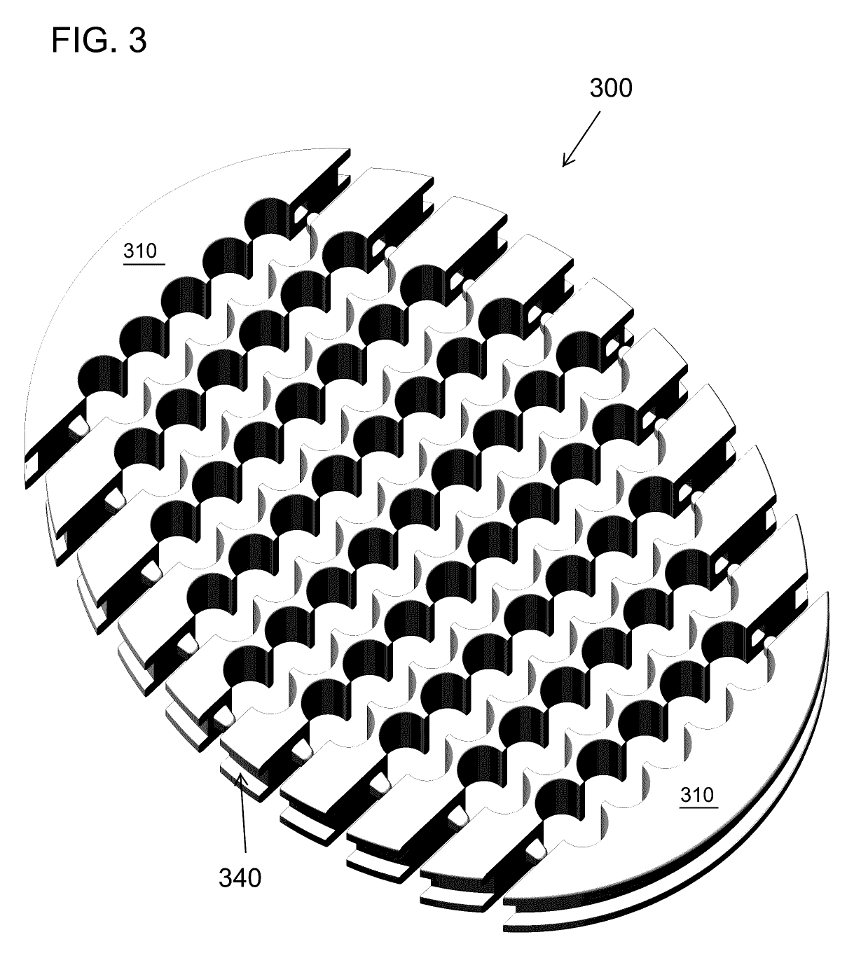

FIG. 3 depicts a free floating member assembly system 300 comprising outer sides comprising outer voids 340 defined by outer extended lips 350. The outer voids 340 provide an advantage in that rubber bands or flexible members may be used to secure a cable system together such that the flexible member will not fall off.

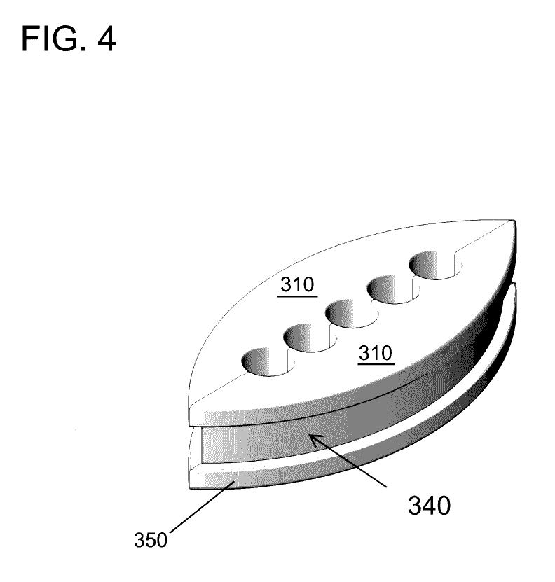

FIG. 4 depicts a disclosed embodiment comprising two free floating end caps 310.

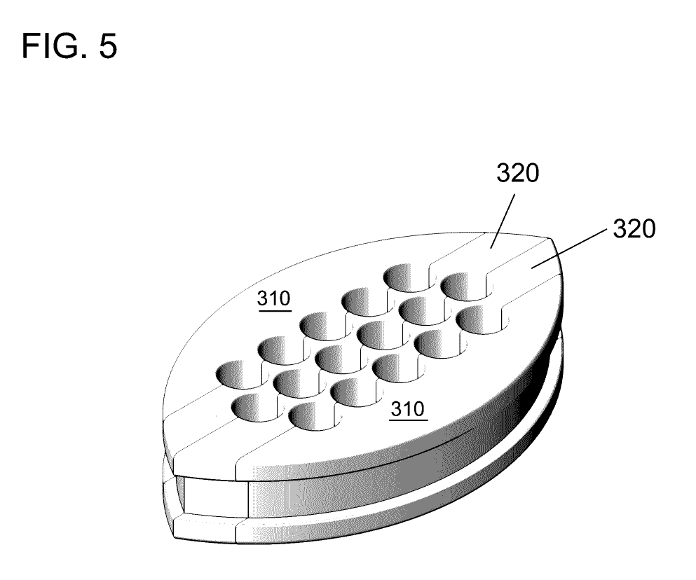

FIG. 5 depicts a disclosed embodiment comprising two free floating end caps 310 and two free floating fingers 320.

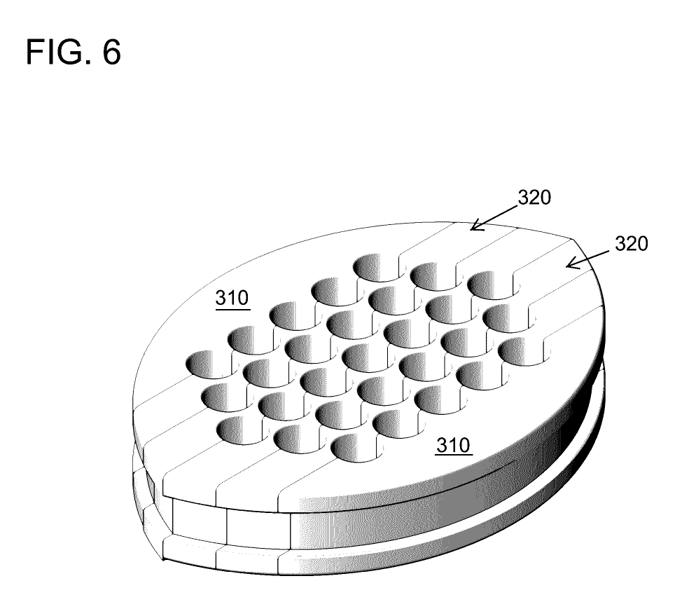

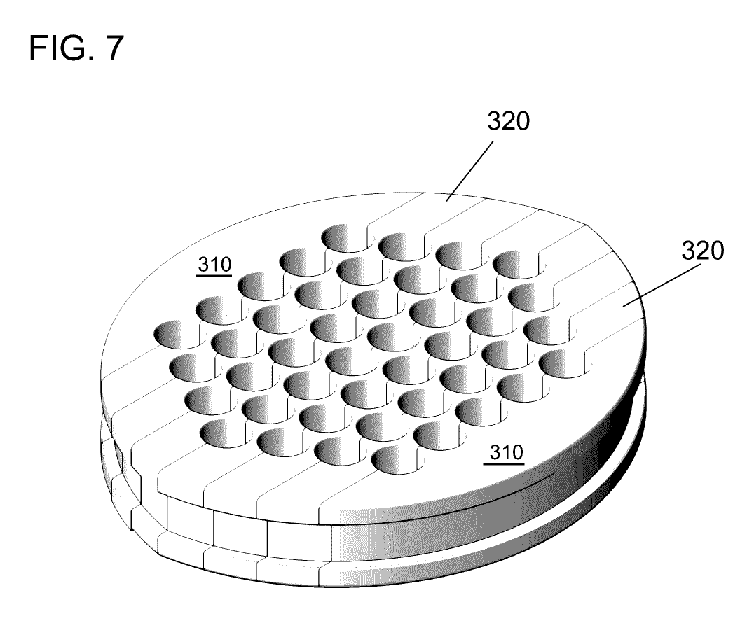

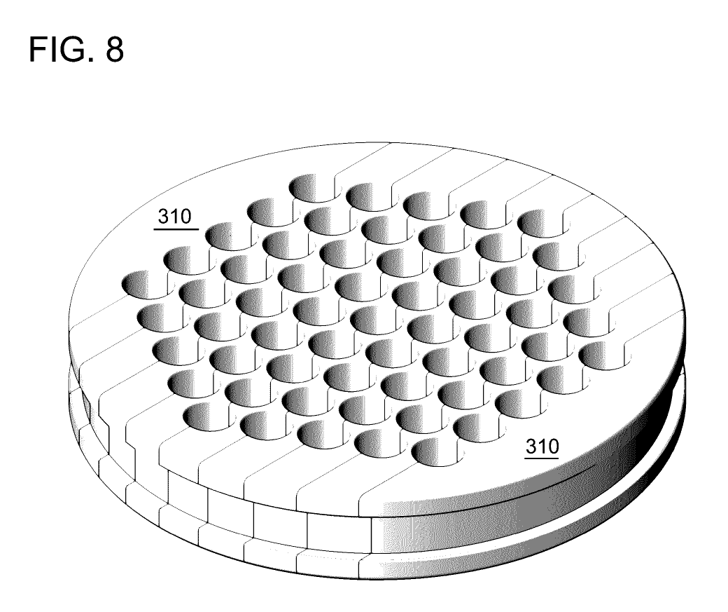

FIG. 6, FIG. 7, FIG. 8 depict various combinations of free floating end caps matted to various numbers of free floating fingers.

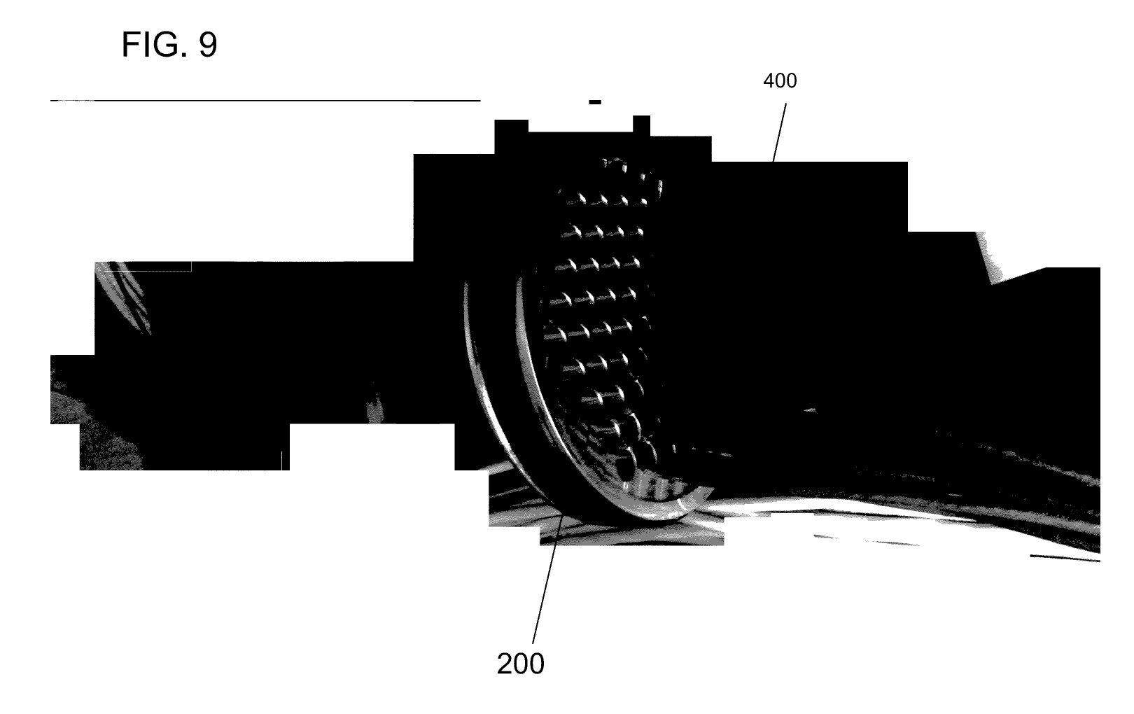

FIG. 9 depicts a cable system in place comprising a plurality of cables 400 with the cable ends not accessible. A disclosed embodiment is shown with a collar system 200. A collar system may comprise a rigid assembly or may comprise a flexible member such as a strap or webbing.

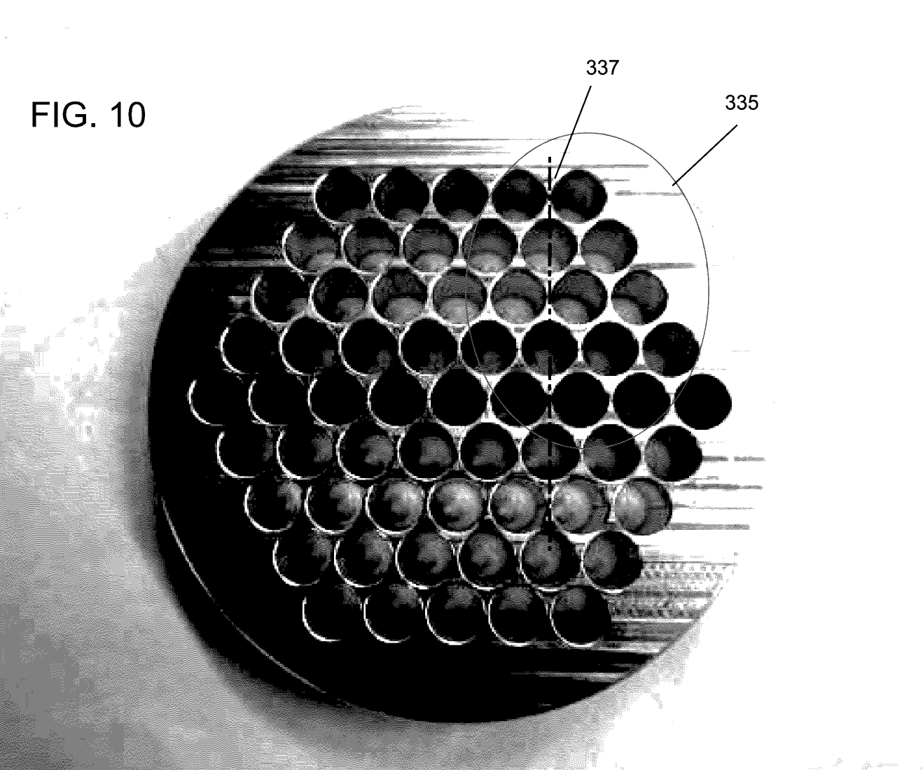

FIG. 10 depicts an assembled embodiment illustrating a configuration 335 of staggered cable voids, with the staggered cable voids further highlighted by the use of a center line 337 of voids and walls.

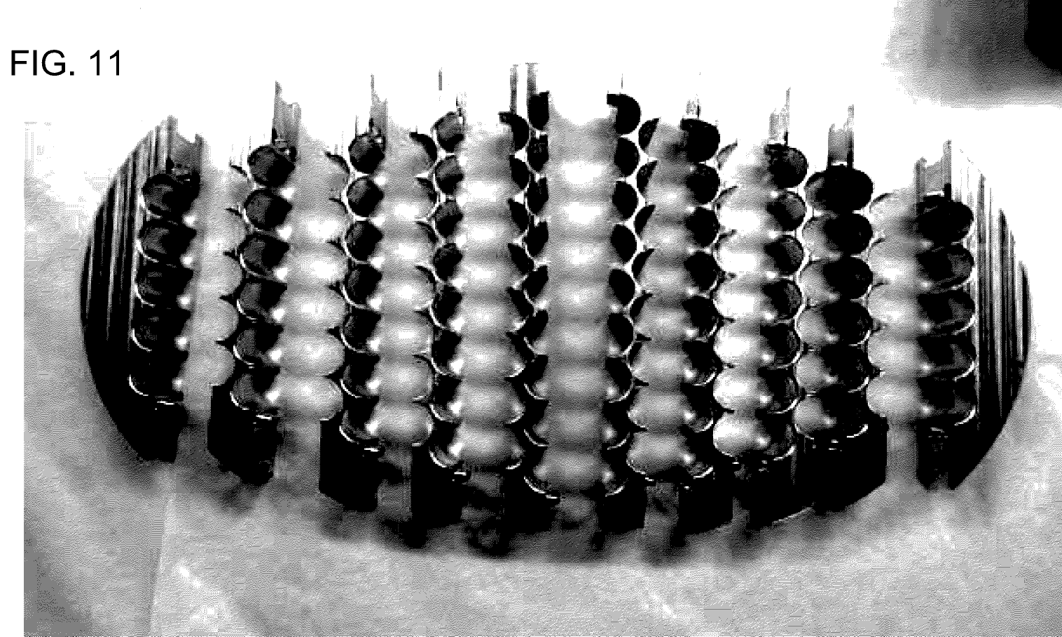

FIG. 11 depicts an exploded view of a disclosed embodiment.

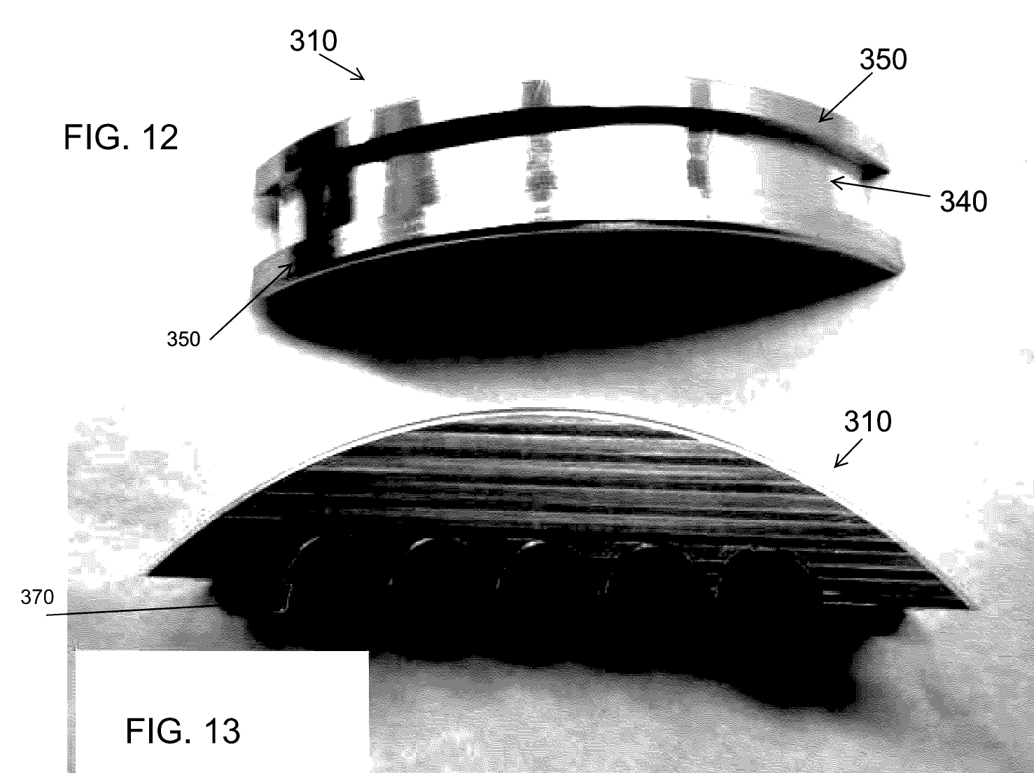

FIG. 12 depicts a perspective view of a free floating end cap 310, the free floating end cap comprising an outer arch area comprising an outer void 340, the outer void defined by a pair of outer extended lips 350.

FIG. 13 depicts a perspective view of a free floating end cap 310, the free floating end cap comprising a connection pin 370.

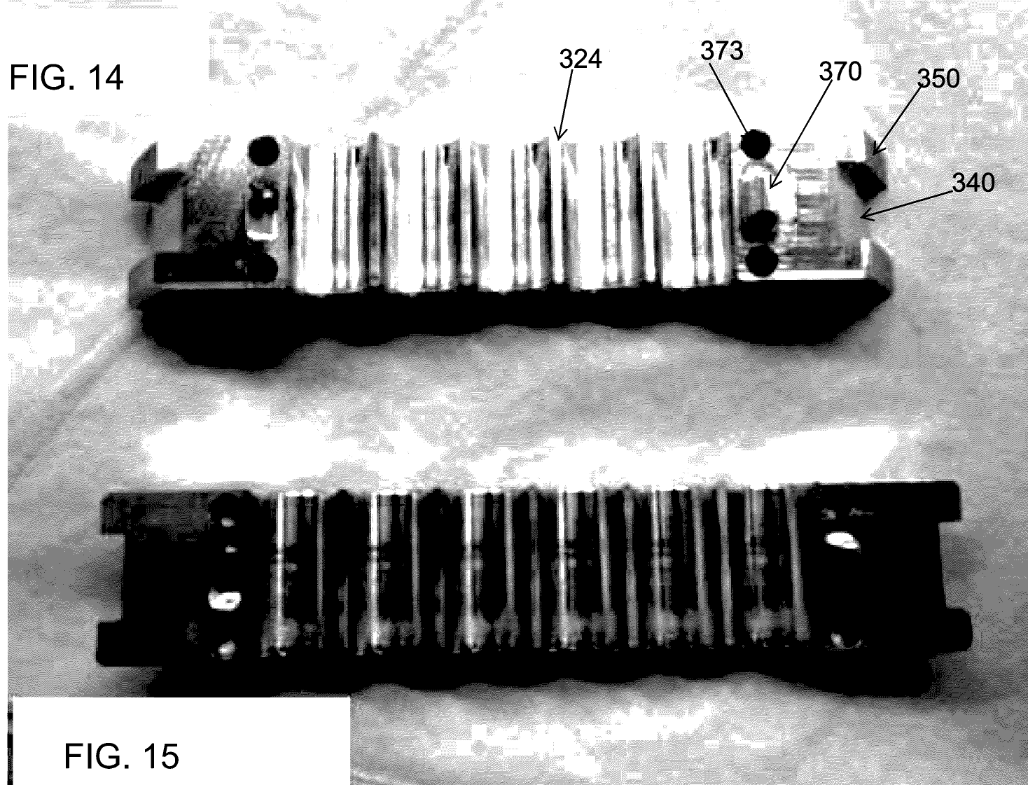

FIG. 14 depicts a perspective view of a free floating member, the free floating member comprising a connection pin 370 and defining one or more connection voids 373.

A connection pin 370 may be disposed within or upon a side block 326 area of a free floating member or a free floating end cap. A connection void 373 may be defined within a side block 326 and may accept a connection pin. The disclosed connection pin and connection void system provides mechanical advantages to allow the free floating end caps and free floating members to be attached to one another without use of tools and without adding bulk or volume to the system. The disclosed connection pin and connection void system are disposed away from the cable voids and wall components so as to not interfere with the retention or combing of cables.

FIG. 15 depicts a perspective view of a free floating member.

What is claimed is:

1. A cable retention and cable combing system (100) used to retain cable without accessing cable ends, the system comprising:
a) a pair of free floating end caps (310) with each free floating end cap comprising a plurality of wall components (324) and a plurality of inner arch components (322) with the wall components and inner arch components defining a plurality of cable voids (330);
b) a free floating member (320) disposed between the pair of free floating end caps, the free floating member also comprising a plurality of wall components (324) and a plurality of inner arch components (322) with the wall components and inner arch components defining a plurality of cable voids (330);
c) the pair of free floating end caps and the free floating member all having a first side and a second side, with the first and second sides comprising outer extended lips (350) with the outer extended lips defining an outer void (340); and
d) a collar system 200 disposed within the outer void, the collar system retaining the pair of free floating caps together with the free floating member.

2. The system of claim 1 wherein the first and second sides of the free floating end caps and free floating member each comprise a side block area (326) with each side block area comprising a connection pin (370) and each side block area defining a connection void (373), with each connection pin inserted into a respective connection void to secure the floating end caps and free floating member to one another.

3. The system of claim 1 further comprising a plurality of free floating members.

4. The system of claim 3 wherein the inner arch components, wall components are disposed to create a configuration (335) of staggered cable voids.

5. The system of claim 4 wherein each of the two free floating end caps comprise an outer arch (312).

6. The system of claim 5 wherein the collar system comprises a top component and a bottom component with the top component and the bottom component each comprising an inner arch (212) that comports to a respective outer arch of the free floating end caps.
